(19) United States
(12) Patent Application Publication
(10) Pub. No.: US 2009/0109055 A1
(43) Pub. Date: Apr. 30, 2009

(54) Method and system for acquiring features of measurement systems

(76) Inventors: Jefferson B. Burch, Palo Alto, CA (US); Glenn R. Engel, Snohomish, WA (US); Glen L. Purdy, JR., Snohomish, WA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/978,771

(22) Filed: Oct. 30, 2007

(51) Int. Cl. G08B 23/00

(52) U.S. Cl. 340/870.02

(57) ABSTRACT

A method including establishing a communication link between one or more measurement equipment installations and a provider of optional features, utilizing circuitry within the measurement equipment installation to allow the measurement equipment installation to exchange information with the provider of optional features and determining optional feature use criteria, the optional feature use criteria including at least an interval during which one or more optional features are enabled on the one or more measurement equipment installations.

### BACKGROUND

The disclosed exemplary embodiments are related to communications between a measurement equipment user and an equipment support center.

Some conventional measurement equipment supports a set of features and options that are generally installed and/or specified in the equipment when the equipment is purchased. Other conventional measurement equipment supports the purchasing of optional features after the initial purchase of the equipment. The optional features may be enabled in the equipment through the use of, for example, codes supplied by the equipment manufacturer or a provider of the optional features. Generally, each option added to a measurement instrument is associated with a significant cost that must be absorbed by the user. If the option or options added to the equipment are only to be used on an infrequent basis or for a limited number of times, the addition of the optional features may not be economically justified.

It would be advantageous to provide optional features for test and measurement equipment in an economical manner.

### SUMMARY

The disclosed embodiments are directed to a method including establishing a communication link between one or more measurement equipment installations and a provider of optional features, utilizing circuitry within the measurement equipment installation to allow the measurement equipment installation to exchange information with the provider of optional features and determining optional feature use criteria, the optional feature use criteria including at least an interval during which one or more optional features are enabled on the one or more measurement equipment installations.

The disclosed embodiments are also directed to a measurement equipment installation including a communication link module configured to establish a communication link between the measurement equipment installation and a provider of optional features, circuitry within the measurement equipment installation configured to exchange information between the measurement equipment installation and the provider of optional features, and a processor within the measurement equipment installation configured to determine optional feature use criteria, the optional feature use criteria including at least an interval during which one or more optional features are enabled on the one or more measurement equipment installations.

The disclosed embodiments are further directed to a system including provider of optional features and a measurement equipment installation in communication with the provider of optional features. The measurement equipment installation including a communication link module configured to establish a communication link between the measurement equipment installation and the provider of optional features, circuitry within the measurement equipment installation configured to exchange information between the measurement equipment installation and the provider of optional features and a processor within the measurement equipment installation configured to determine optional feature use criteria, the optional feature use criteria including at least an interval during which one or more optional features are enabled on the one or more measurement equipment installations.

### BRIEF DESCRIPTION OF THE DRAWINGS

The foregoing aspects and other features of the presently disclosed embodiments are explained in the following description, taken in connection with the accompanying drawings, wherein:

FIG. 1 shows a block diagram of an exemplary system suitable for practicing the disclosed embodiments;

FIG. 2 shows a block diagram of an exemplary option support center of the system of FIG. 1;

FIG. 3 shows an exemplary measurement equipment installation;

FIGS. 4A and 4B show an option support function of the disclosed embodiments; and

FIGS. 5 and 6 shows flow diagrams of exemplary operations of the disclosed embodiments.

### DETAILED DESCRIPTION

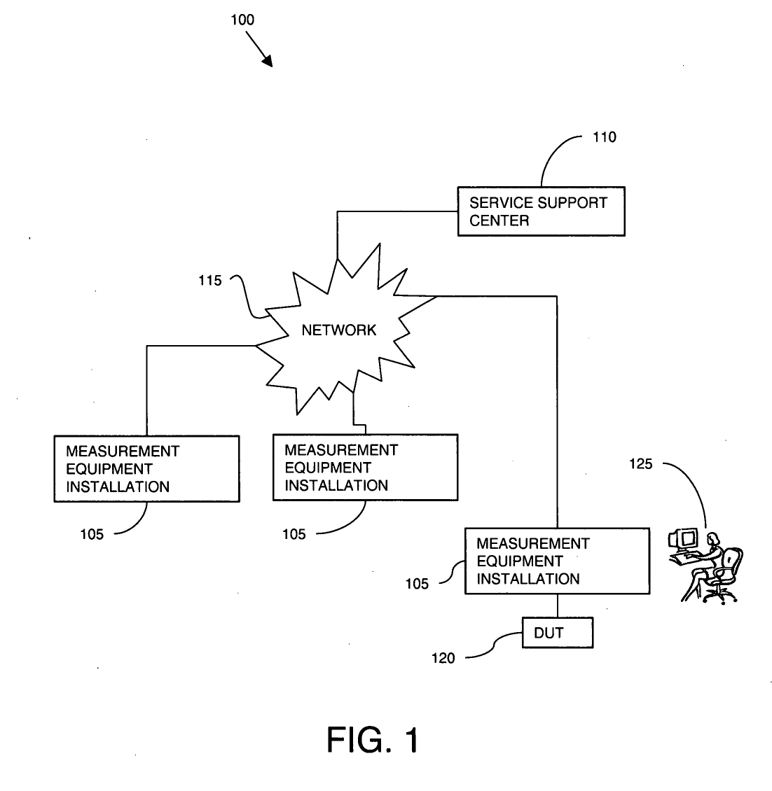

FIG. 1 shows a block diagram of a system 100 suitable for practicing the embodiments disclosed herein. Although the presently disclosed embodiments will be described with reference to the drawings, it should be understood that they may be embodied in many alternate forms. It should also be understood that In addition, any suitable size, shape or type of elements or materials could be used.

System 100 includes one or more measurement equipment installations 105 connected to a service support center 110 through a network 115. The network may be any suitable network as will be described below. A measurement equipment installation 105 may include various measurement system components including, but not limited to, a signal preparation unit and a signal generator unit for applying signals to a device under test (DUT) 120 and a receiver and analyzer for receiving and analyzing resulting signals from the DUT 120 or any other suitable measuring system components.

It is a feature of the disclosed embodiments to allow any suitable optional features of the measurement equipment installations 105 to be activated or enabled on the measurement equipment installations 105 in a cost effective manner. Examples of optional features include, but are not limited to, extended frequency ranges of the measurement instrument, different ranges of measuring timing, extended ranges of frequency generation, different equipment analyzer capabilities, different test vector capabilities, and different filtering features of the equipment.

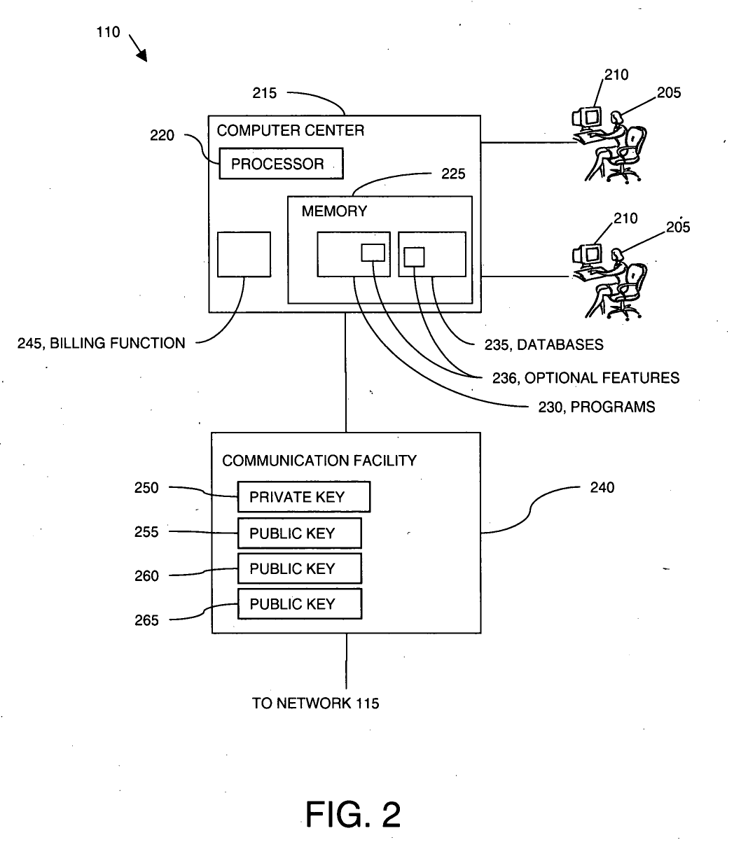

Turning to FIG. 2, in one exemplary embodiment, the service support center 110 may generally include support personnel 205 with terminals 210 connected to a computer center 215. The computer center 215 may include one or more processors 220 and memory devices 225 with programs 230 and databases 235 for storing information related to the optional features 236 of the measurement equipment installations 105, capabilities and or installed options of different measurement equipment, troubleshooting procedures, measurement equipment setup information and procedures, records of previous support activities or optional feature purchases, and other customer support information.

At least one of the processors 220 operates under control of the programs 230 to perform operations according to the disclosed embodiments. The programs 230 may be embodied on a computer readable medium, for example, at least one of the memory devices 225. The one or more memory devices 225 may include magnetic, optical, semiconductor, or any other type of computer readable storage medium. In some embodiments the stored information related to the optional features of the measurement equipment installations may include procedures for retrieving information related to various aspects of the measurement equipment installations 105, capabilities of different measurement equipment, troubleshooting procedures, and measurement equipment setup information and procedures.

The measurement equipment procedures, including the enabling of the optional features 236, may be implemented as interactive procedures. The interactive procedures may involve the support personnel or may be implemented as automated programs. The measurement equipment procedures may also be implemented as part of the programs 230. In addition, the service support center may include a billing function 245 for collecting costs associated with providing the optional features 236 to the measurement equipment installations 105 and optionally allocating the costs among the measurement equipment installations, billing for customer support, or generally tracking optional feature costs and or support costs, as appropriate. The billing function may be implemented using the one or more processors 220 and memory devices 225 with programs 230 and databases 235.

The service support center 110 may also provide a communication facility 240 for communicating with the one or more measurement equipment installations 105 and measurement equipment users 125 through the network 115. The communications facility 240 generally includes communications hardware and software for establishing any suitable link between the service support center 110 and a measurement equipment installation 105. The communications facility 240 may also include a private security key 250 for the service support center 110 and public keys 255, 260, 265, etc. for each of the measurement equipment installations 105 for authentication and secure communication.

It should be understood that while one service support center is shown, the service support center 110 may represent a number of service support centers that may be located together or geographically distributed.

The network 115 may be any suitable communications network including, but not limited to the Public Switched Telephone Network (PSTN), a wireless network, a wired network, a Local Area Network (LAN), a Wide Area Network (WAN), a virtual private network (VPN), cellular networks, the Internet and the World Wide Web. Communication between the service support center 110 and the measurement equipment installations 105 may be achieved using any suitable protocol or modulation standard, for example, X.25, ATM, TCP/IP, V34, V90, etc. Network 115 may also include a wireless network with an air interface utilizing any suitable wireless communication protocol or signaling techniques or standards including, but not limited to, TDMA, CDMA, IEEE 802.11, Bluetooth, close range RF, optical, any appropriate satellite communication standards.

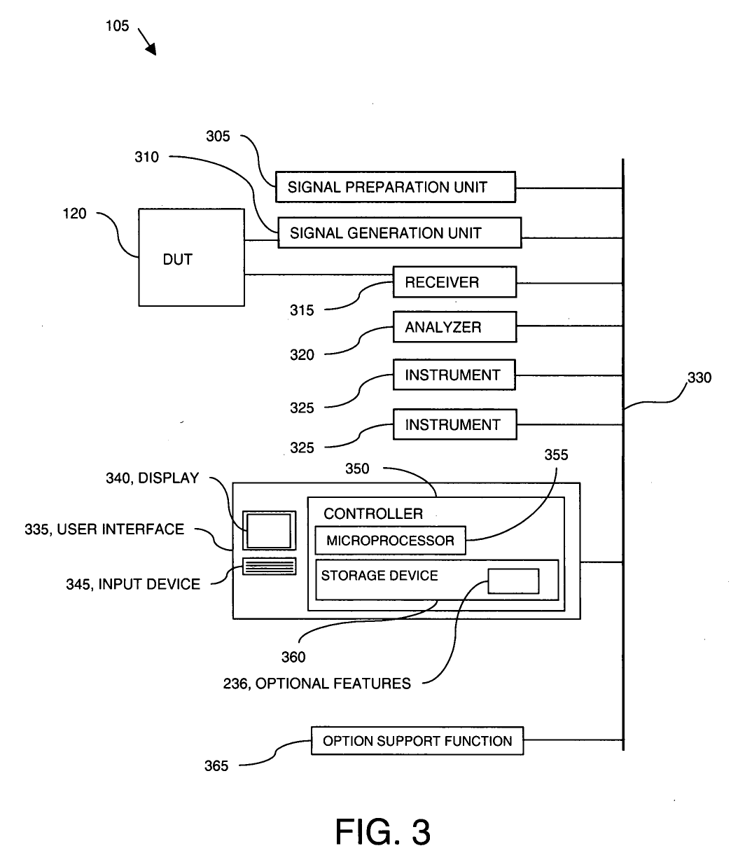

FIG. 3 shows a more detailed view of an exemplary measurement equipment installation 105. As mentioned above, a measurement equipment installation 105 may include one or more of a signal preparation unit 305, signal generation unit 310, receiver 315, and analyzer 320. The signal preparation unit 305 may perform calculations of one or more test patterns, also referred to as test vectors, for obtaining measurements from the DUT 120. The test patterns may include digital, analog, optical, or any suitable type of test signal. The signal generation unit 310 may provide the signals to the DUT 120 through a hardware interface, for example, using one or more cables, an air interface, for example, using a broadcast transmission, or any other conveyance suitable for providing signals to the DUT 120.

When the test patterns are provided to the DUT 120, the DUT in return provides response signals, such as digital, analog, optical, or any types of signals. The response signals may be different in form from the test patterns, for example, a combination of analog and optical signals may result in the DUT producing digital signals as a response. The receiver 315 operates to convey the response signals from the DUT 120 to the analyzer 320. In some embodiments the receiver 315 may include components for conditioning the response signals before conveying them to the analyzer 320. The analyzer 320 may evaluate the DUT's responses to the test patterns and may provide an indicator, for example one or more signals, of the evaluation. The indicators provided by the analyzer may simply include a measurement of the DUT's response, a comparison of the DUT's response with an expected response, a pass/fail indication, an analysis of the DUT's response with specific component failures, or any other suitable analysis of the DUT response.

In some embodiments the signal preparation unit 305 and signal generation unit 310 may be combined to perform a specialized or dedicated type of stimulus function or provide a specific type of signal, for example, a frequency generator or an arbitrary waveform generator. Similarly, in some embodiments the receiver 315 and analyzer 320 may be combined to provide a specialized or dedicated analysis function, as in the example of an oscilloscope. Measurement system components including those with dedicated or specialized functions may be referred to as instruments 325.

A measurement equipment installation 105 may include one or more of, or any combination of, signal preparation units, signal generation units, receivers, analyzers, or dedicated instruments, and may be modular and scalable so that necessary measurement system components may be assembled together as required. The measurement system components may be interconnected to each other, or in some embodiments may be connected by a common bus 330 for communication with each other.

The measurement equipment installation 105 may also include a user interface 335. The user interface may be a separate component of the measurement equipment installation 105 or may be incorporated as part of one or more instruments 325. The user interface 335 may include a display 340, at least one input device 345, and a controller 350. The display 335 may utilize LCD, flat panel, plasma, or any other type of suitable technology. The at least one input device 345 may include one or more buttons, a keypad, keyboard, a pointing device such as a mouse or trackball, etc. for selecting a number of options and embellishments of a product as will be described below. The controller 350 may include a microprocessor 355 or other appropriate circuitry for controlling the operations of the user interface and/or the measurements performed by the measurement equipment installation 105. The controller 350 may also include a storage device 360 embodied as a computer readable medium that generally stores machine readable program code which is adapted to cause the controller to perform the functions of the disclosed embodiments. The storage device may also be configured to store the optional features of the measurement equipment installation 105. The storage device 360 may utilize optical, magnetic, semiconductor, electronic, or other types of suitable devices to store the program code.

Other examples of a user interface may include a consumer computing device such as a personal digital assistant (PDA), cellular telephone, desktop, laptop, notebook, etc. The user interface 335 may include any computing device capable of providing the functions described herein.

The measurement equipment installation 105 may also include a built in option support function or module 365 configured to allow a user 125 to acquire optional features of the measurement equipment installation 105. In some embodiments the entire option support function 365 may be implemented as a separate component of the measurement equipment installation. For example, where the measurement equipment installation includes instruments 325 connected by a bus 330, the option support function 365 may be provided, or even retrofitted, as a modular component on the bus 330. While shown as a component of a measurement equipment installation 105, it should be understood that the option support function 365 may also be implemented as a function distributed among any number of measurement system components. In other embodiments, the option support function 365 may be integrated into the user interface 335, one or more measurement system components, or instruments 325 including, but not limited to, a customer support feature of the measurement equipment installation.

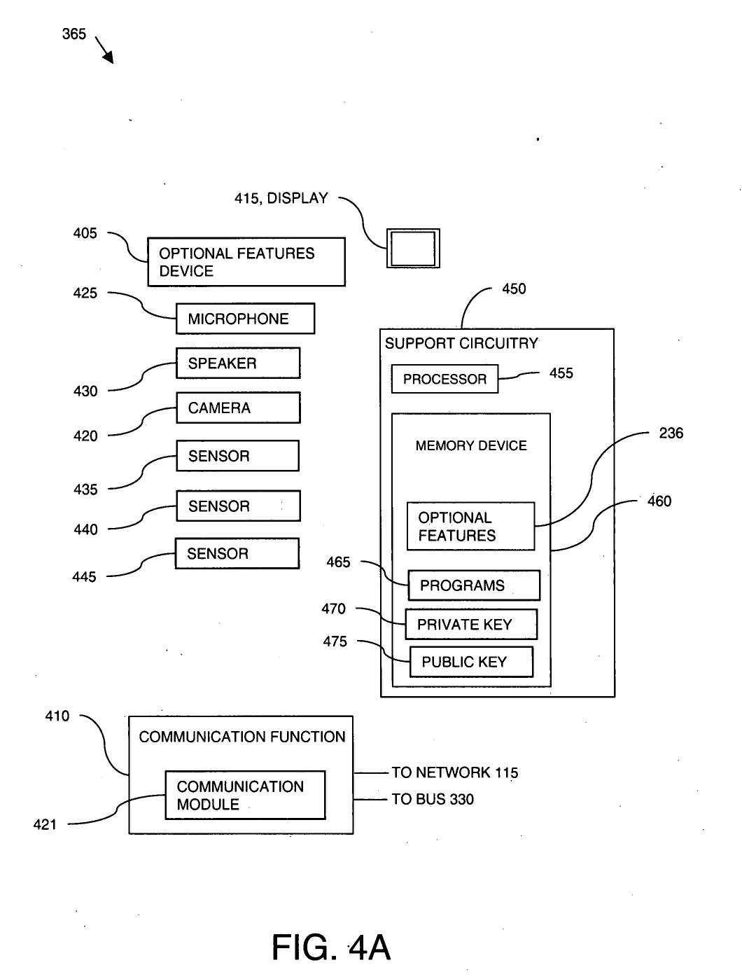

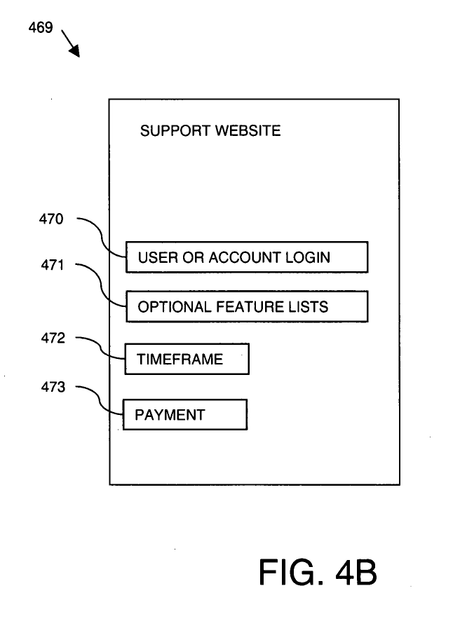

FIG. 4 shows the option support function 365 in greater detail. The option support function 365 may include a device 405 that initiates the purchase of optional features 236. In one exemplary embodiment the device 405 may be a physical button or virtual button presented on the display 340 that may be activated for initiating a communication link as described below.

The option support function 365 may also include a communication function or module 410 that is capable of establishing a link with the service support center 110 for exchanging information through network 115. This communication link may be established in any suitable manner including, but not limited to, the activation of the device 405 or automatically as will be described below. The communication function 410 may generally include circuitry and programs for providing a direct or secure communication link between the measurement equipment installation 105 and the service support center 110. In one exemplary embodiment, the direct communication link may be a link to, for example, a support website 469 hosted by the computer center 215 as shown in FIG. 4B. The website may be presented on the display 340 and navigated through the use of the at least one input 345. The support website 469 may have any suitable interface features including, but not limited to, a user or account login 470, optional feature lists 471 associated with one or more type and configuration of measurement equipment installations, an area to specify or choose a timeframe 472 that the optional features will be enabled (as will be described in greater detail below), an area to specify payment for the option 473 (e.g. user account, credit card or other suitable payment options). It is noted that the above features of the website 469 are only exemplary and the website 469 may include any suitable user interface features for purchasing optional features 236 for the measurement equipment installations 105. It is also noted that the different website features 470-473 may be located on one or more pages of the website. In alternate embodiments the website may have any suitable configuration. In alternate embodiments the direct link may provide a link between the measurement equipment installation 105 and any suitable automated provider of optional features.

In another exemplary embodiment, the direct communication link may include, for example, an instant messaging (IM) client or other suitable “chat” type technology, a plain old telephone service (POTS) connection, a voice over IP (VOIP) connection, a video connection, a multimedia message exchange, a network connection, or any suitable messaging, voice, video, data, or information exchange link. These communication links may allow a user 125 to purchase optional features 236 in a substantially live environment (e.g. the purchase of optional features is performed between the user 125 and a live support person 205). In other exemplary embodiments, the optional features 236 may be purchased through a combination of the automated and live environments.

For embodiments where the option support function 365 is connected to the common bus 330, the communication function 410 may also include a module 421 with circuitry for providing communication among the option support function 365 and other instruments of the measurement equipment installation 105.

The option support function 365 may also include communication devices, circuitry, and programs. For example, the option support function 365 may include components of the user interface 335, for example, display 340 and input device 345, one or more of an additional display 415, a camera 420, microphone 425, speaker 430, sensors 435, 440, 445 and other communication devices for providing communication with the measurement equipment installation user 125. The support circuitry 450 may include circuitry for using the communication devices, for example, display 415, camera 420, microphone 425, speaker 430, and sensors 435, 440, 445 as a telephone, videophone, or any other suitable interactive interface or communication apparatus between the measurement equipment user 125 and the service support center 110.

The support circuitry 450 may also include a processor 455 and a memory device 460. The processor 455 may operate under control of programs to perform purchasing of optional features 236 according to the disclosed embodiments. The communication devices, circuitry and programs may support a measurement equipment user voice recognition capability that may be used to purchase the optional features through the website 469 or through an automated voice messaging/purchasing system. The programs 465 may be embodied on a computer readable medium, for example, memory device 460. The memory device 460 may optionally store the purchased optional features 236. The memory device 460 may also include a private key 470 for the measurement equipment installation 105 and a public key 475 for the service support center 110 for authentication and secure communication. The one or more memory devices 225 may include magnetic, optical, semiconductor, or any other type of computer readable storage medium.

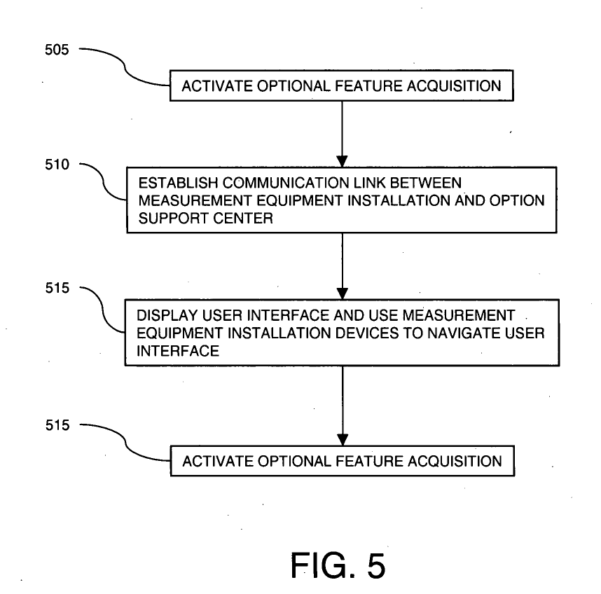

Exemplary operations of the disclosed embodiments will now be described. Referring to FIG. 5, in one exemplary embodiment, the measurement equipment user 125 may activate device 405 or initiate a communication link between the option support function 365 and the service support center 110 in any suitable manner (FIG. 5, Blocks 500-505). The option support function 365 may initiate communication by encrypting an identification message with the measurement equipment installation's private key 470 and sending it to the service support center 110. The identification message may include an identifier of the measurement equipment installation, for example, a serial number, a name, a customer account code, or any other measurement equipment installation identifying information. Upon receipt, the service support center 110 may decrypt the message with the measurement equipment installation's public key 255 and authenticate the measurement equipment installation 105 by confirming that the measurement equipment installation identifier matches the identifier associated with the public key 255.

The service support center 110 may respond with an identification message encrypted with the service support center's private key 250. The service support center's identification message may include an identifier similar to the measurement equipment installation identifier that clearly identifies the service support center 110. Upon receipt, the measurement equipment installation 105 may decrypt the message with the service support center's public key and authenticate the service support center 110 by confirming that the service support center identifier matches the identifier associated with the public key 475. Subsequently all communication between the measurement equipment installation 105 and the service support center may be encrypted with private keys and decrypted with public keys in a similar fashion, ensuring secure authenticated communication.

In this example, activation of the device 405 may cause the web page 469 or any other suitable user interface for acquiring optional features to be presented on the display 340 (FIG. 5, Block 510). The user interface 335 of the measurement equipment installation 105 may be configured to allow the user 125 to navigate the web page 469 (e.g. through the input device 345, a touch screen device, motion sensors, etc.) for selection of one or more optional features that are to be enabled on the measurement equipment installation 105 (FIG. 5, Block 515). As described above, the user 125 may enter an account number or user login so that the purchase of one or more optional features 236 may be billed to, for example, the user 125, the user's employer or any other entity responsible for payment of the use of the optional features 236.

As also described above, the web page 469 may be configured to allow the user 125 to specify an interval during which the optional features 236 will be enabled on the measurement equipment installation 105. For example, the user may specify that the optional feature is to be enabled on or in the measurement equipment installation 105 for a predetermined time frame (e.g. minutes, hours, days, weeks, months, etc.), a predetermined number of uses or a predetermined time frame after the optional feature is first used. In other embodiments the interval may be any suitable criteria for gauging the use of the optional feature. It is noted that in the exemplary embodiments disclosed herein, the optional feature(s) may be preinstalled (but are disabled) at the measurement equipment installation 105 or they may be downloaded into the measurement equipment installation 105 when purchased as described herein. After the purchase of the optional feature(s) 236 the feature(s) 236 become enabled for use. After the interval of use expires the optional feature(s) return to a disabled state and/or are removed from the measurement equipment installation 105. The removal of the optional feature(s) may be automatic after the interval of use expires.

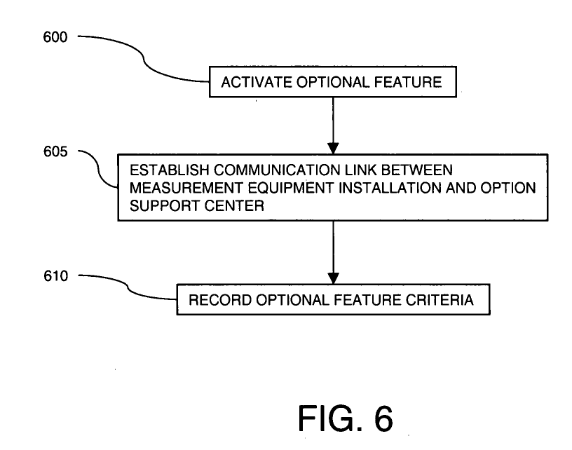

In another exemplary embodiment, referring to FIG. 6, the optional feature(s) 236 may be activated or used by the user 125 (FIG. 6, Block 600). Upon activation of the optional feature(s) 236 the measurement equipment installation 105 may be configured to automatically establish a communication link with the service support center 110 (FIG. 6, Block 605). The measurement equipment installation 105 may indicate to the service support center 110 in any suitable manner that one or more optional features are being enabled and used in the measurement equipment installation 105. The service support center 110 may be configured to record the interval during which the optional feature(s) are enabled charging the user's account for billing purposes (FIG. 6, Block 610).

In still other exemplary embodiments, the limited usage optional feature(s) may be enabled by the user 125 in any suitable manner including, but not limited to, automated voice systems where the user 125 can specify the optional feature as well as the interval during which the feature is to be enabled. The automated voice systems may include the above mentioned features of the website 469 described above. In other embodiments the automated voice systems may include any suitable options/selections for allowing a user to the enable optional feature(s) 236.

In another aspect of the disclosed embodiments, the communication link between the measurement equipment installation 150 and service support center 110 may be configured to allow downloading of demonstration licenses for the optional features 236 or any other suitable measurement equipment installation software. This would allow a user to try the feature or other software before purchasing it.

In still another aspect of the disclosed embodiments, the service support center 110 may provide additional features through the website 469 or other suitable user interface. In one example, where the features enabled in the measurement equipment installation 105 involve analysis of measured data, the website 469, for example, could include features for providing a convenient way to upload the measured data to any suitable server. The support center 110 may be configured to store the data and/or analyze the data for an additional fee. The fee may be a subscription fee (e.g. regular billing cycles such as per year, per month, per week, etc.) or on a pay-per-use basis.

Allowing a user of one or more measurement equipment installation 150 to purchase optional features 236 on a pay-per-use basis in accordance with the disclosed embodiments provides a cost effective and efficient manner of obtaining the optional features for limited use.

It should be understood that the foregoing description is only illustrative of the present embodiments. Various alternatives and modifications can be devised by those skilled in the art without departing from the embodiments disclosed herein. Accordingly, the embodiments are intended to embrace all such alternatives, modifications and variances which fall within the scope of the appended claims.

What is claimed is:

1. A method comprising:
establishing a communication link between one or more measurement equipment installations and a provider of optional features;
utilizing circuitry within the measurement equipment installation to allow the measurement equipment installation to exchange information with the provider of optional features; and
determining optional feature use criteria, the optional feature use criteria including at least an interval during which one or more optional features are enabled on the one or more measurement equipment installations.

2. The method of claim 1, wherein the interval during which the one or more optional features are enabled includes one or more of a predetermined period of time, a predetermined number of uses and a predetermined period of time after each of the one or more optional features are first used.

3. The method of claim 1, wherein establishing a communication link includes, activating an optional feature acquisition unit of the one or more measurement equipment installations and providing authenticated and encrypted communication between the measurement equipment installation and the provider of optional features.

4. The method of claim 3, further comprising displaying a user interface of the provider of optional features on a display of the one or more measurement equipment installations, the user interface being configured to allow for at least a selection of one or more optional features and specifying the interval which the one or more optional features are enabled.

5. The method of claim 1, wherein establishing a communication link includes automatically establishing a communication link upon use of the one or more optional features.

6. The method of claim 1, wherein a user of the one or more measurement equipment installations is billed on a pay-per-use basis for using the optional feature.

7. The method of claim 1, further comprising uploading measured data from the one or more measurement equipment installations to the provider of optional features for analysis and/or storage.

8. A measurement equipment installation comprising:
a communication link module configured to establish a communication link between the measurement equipment installation and an provider of optional features;
circuitry within the measurement equipment installation configured to exchange information between the measurement equipment installation and the provider of optional features; and
a processor within the measurement equipment installation configured to determine optional feature use criteria, the optional feature use criteria including at least an interval during which one or more optional features are enabled on the one or more measurement equipment installations.

9. The measurement equipment installation of claim 8, wherein the interval during which the one or more optional features are enabled includes one or more of a predetermined period of time, a predetermined number of uses and a predetermined period of time after each of the one or more optional features are first used.

10. The measurement equipment installation of claim 8, wherein the processor is further configured to activate an optional feature acquisition unit of the measurement equipment installation.

11. The measurement equipment installation of claim 10, wherein the processor is further configured to display a user interface of the provider of optional features on a display of the measurement equipment installation, the user interface being configured to allow for at least a selection of one or more optional features and specifying the interval which the one or more optional features are enabled.

12. The measurement equipment installation of claim 8, wherein the communication link is established upon use of the one or more optional features and the circuitry within the measurement equipment installation is configured to provide authenticated and encrypted communication between the measurement equipment installation and the provider of optional features.

13. The measurement equipment installation of claim 8, wherein a user of the measurement equipment installation is billed on a pay-per-use basis for using the optional feature.

14. The measurement equipment installation of claim 8, wherein the processor is further configured to upload measured data from the one or more measurement equipment installations to the provider of optional features for analysis and/or storage.

15. A system comprising:
a provider of optional features; and
a measurement equipment installation in communication with the provider of optional features, the measurement equipment installation including:
a communication link module configured to establish a communication link between the measurement equipment installation and the provider of optional features;
circuitry within the measurement equipment installation configured to exchange information between the measurement equipment installation and the provider of optional features; and
a processor within the measurement equipment installation configured to determine optional feature use criteria, the optional feature use criteria including at least an interval during which one or more optional features are enabled on the one or more measurement equipment installations.

16. The system of claim 15, wherein the interval during which the one or more optional features are enabled includes one or more of a predetermined period of time, a predetermined number of uses and a predetermined period of time after each of the one or more optional features are first used.

17. The system of claim 15, wherein the processor is further configured to display a user interface of the provider of optional features on a display of the measurement equipment installation, the user interface being configured to allow for at least a selection of one or more optional features and specifying the interval which the one or more optional features are enabled.

18. The system of claim 15, wherein the communication link is established upon use of the one or more optional features and the circuitry within the measurement equipment installation is configured to provide authenticated and encrypted communication between the measurement equipment installation and the provider of optional features.

19. The system of claim 15, wherein a user of the measurement equipment installation is billed on a pay-per-use basis for using the optional feature.

20. The system of claim 15, wherein the processor is further configured to upload measured data from the one or more measurement equipment installations to the provider of optional features for analysis and/or storage.
